(19) United States
(12) Patent Application Publication
(10) Pub. No.: US 2007/0281732 A1
(43) Pub. Date: Dec. 6, 2007

(54) Method and system for securing a hands-free headset portion of a communication system

(76) Inventor: Peter Michael Fox, Summerland Key, FL (US)

Correspondence Address: PETER M. FOX, 959 EAST CARIBBEAN DR, SUMMERLAND KEY, FL, 33042, US

(21) Appl. No.: 11/445,986

(22) Filed: Jun. 2, 2006

(51) Int. Cl. H04M 1/00

(52) U.S. Cl. 455/550.1

(57) ABSTRACT

The method and system for securing the communication system; including a first portion for computing/communicating with outside devices, a second devise for communicating with the first portion, a third portion for coupling said first and second portions and a fourth portion for securing said second portion from accidental activation. Said second portion including a manual means for switching the device to a sleep mode to conserve battery life and avoid erroneously transmitting data, placing and receiving calls.

### BACKGROUND OF THE INVENTION

1. Field of the invention

This invention relates to a system for securing a hands-free headset device such as a Bluetooth headset as an integral part of a communication system.

2. Discussion of Background

In recent years, a system has been developed for carrying various personal computers, cellular phones and palm pilot devices. The system consists of a plastic, fabric or leather carrying portion with the means of securing the personal computer, cellular phone or palm pilot, and an exposed clip for attaching the device to a belt or other accessory, or a shoulder strap for convenience in carrying the device.

However, with the advent of miniturization and advances in voice recognition, text messaging, and wireless internet; a wireless headset has become an integral part of the communication system. The above, as well as other systems for carrying personal computers, cellular phones, and palm pilots, have not contemplated the need for securing a hands-free headset device, such as the bluetooth or other device, as an integrated part of the system. The existing system in many occasions results in lost hands-free headsets. The system is further flawed in that by not protecting the hands-free headset portion of the system from accidental activation while in a pocket or purse, the hands-free headset portion can erroneously transmit data, (ex. answer and place calls) should it be in the active mode. No provision has been made for placing the hands-free headset portion in a manual sleep mode.

### SUMMARY OF INVENTION

Accordingly, one object of this invention is to provide a novel system and method for securing the hands-free headset portion of the communication system.

Another object of this invention is to provide a novel system and method for securing a hands-free headset portion to an existing personal computer portion, and/or personal computer, cellular phone, or palm pilot portion carrying case.

Another object of this invention is to provide a novel system and method for avoiding erroneously answered or placed calls or transmitted data due to the accidental operation of the hands-free headset portion.

Another object of the present invention is to provide a novel system and method so that the hands-free headset portion is not required to be worn at times other than when in use.

Another object of the present invention is to provide a novel method and system to avoid loosing the hands-free headset portion while not in use.

It is yet another object of the present invention to provide a novel method and system for securing both the hands-free headset portion and the personal computer, cellular phone, or palm pilot portion when not in use.

It is noted that one objective of the present invention is to establish a basic method and system for securing the hands-free headset portion with a personal computer, cellular phone, or palm pilot portion to create a secure communication system.

The above and other objectives are achieved according to the present invention by providing a new and improved system and method for securing, not only the personal computer, cellular phone, or. palm pilot portion of the system, but the hands-free headset portion of the system as one device.

Accordingly a second aspect of the present invention, is to modifying an existing personal computer, or carrying method and system to incorporate for securing a hands-free headset portion of the operating system.

Accordingly a third aspect of the present invention, is to provide a new and improved system to secure the hands-free headset portion of the communication system.

### BRIEF DESCRIPTION OF THE DRAWINGS

A more complete appreciation of the invention and many of the intendant advantages thereof will be readily obtained as the same becomes better understood by reference to the following detailed descriptions when considered in conjunction with the accompanying drawings, wherein:

FIG. 1 illustrates a sectional view through an existing carrying system;

FIG. 2 illustrates an isometric view of the modified carrying system according to the present invention;

FIG. 3 illustrates a top view of the modified carrying system according to the present invention;

FIG. 4 illustrates an isometric view of the modified carrying system according to the present invention;

FIG. 5 illustrates a plan view of a modified hands-free device according to the present invention;

FIG. 6 illustrates an isometric view of the modified personal computer according to the present invention;

### DESCRIPTION OF THE PREFERRED EMBODIMENTS

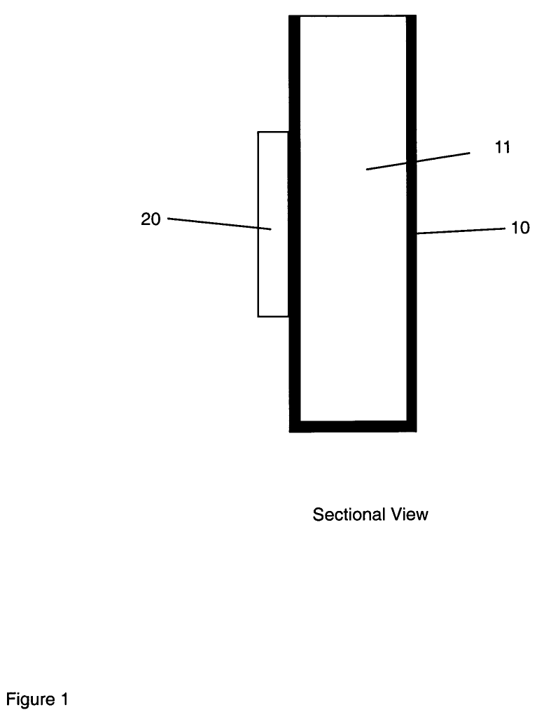

Referring now to the drawings, wherein like reference numerals designate identical on corresponding parts throughout the several views, and more particularly to FIG. 1 thereof there is illustrated a standard valve system.

Referring to FIG. 1, sectional view through an existing carrying system; indicating a case 10, an interior 11 for inserting the personal computer, cellular phone, or palm pilot, and a clip 20 for securing the device to a belt or other accessory.

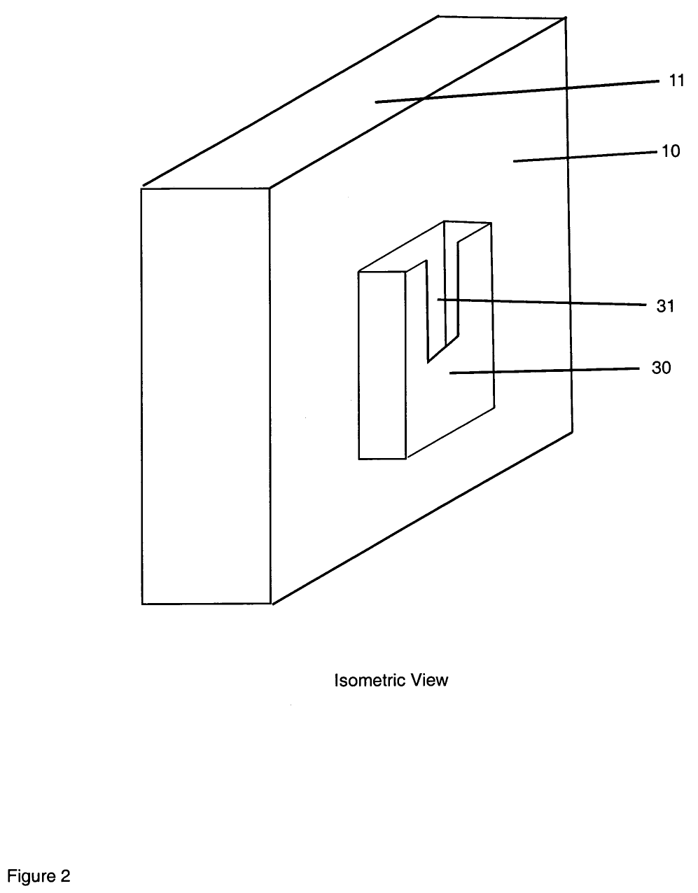

Referring to FIG. 2, an isometric view of the modified carrying system according to the present invention; indicating a case 10, an interior 11 for inserting the personal computer, cellular phone or palm pilot, an added headset case portion 30, and an interior 31 for inserting the hands-free device.

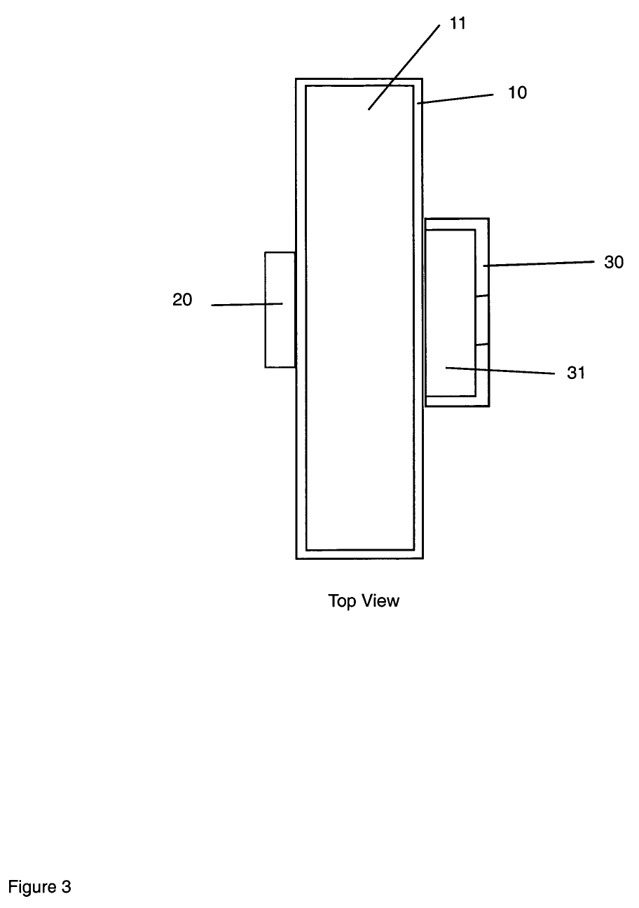

Referring to FIG. 3, a top view of the modified carrying system according to the present invention; indicating a case 10, an interior 11 for inserting the cellular phone or palm pilot, a clip 20 for securing the device to a belt or other accessory, an added headset case portion 30, and an interior 31 for inserting the hands-free device.

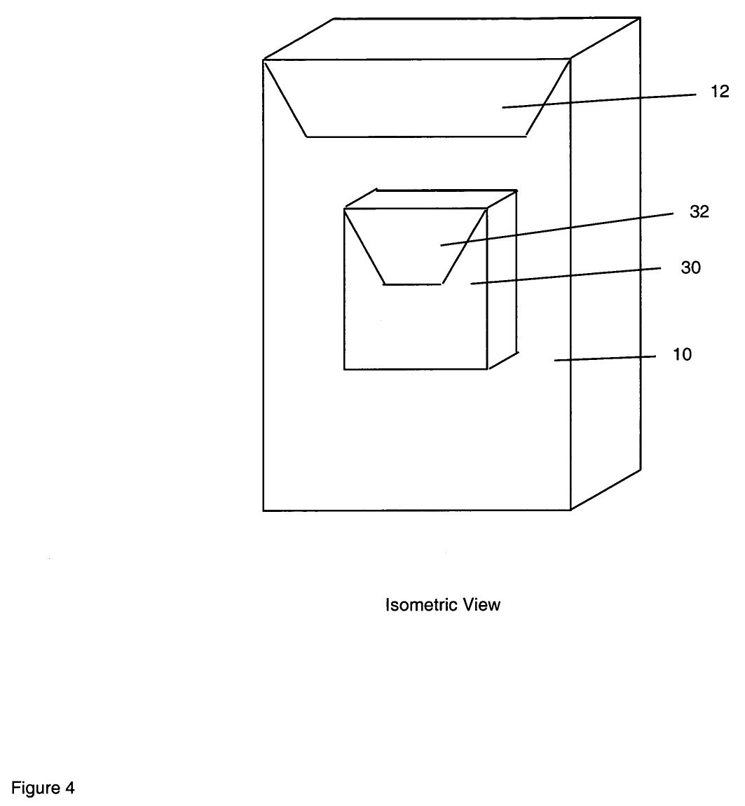

Referring to FIG. 4, an isometric view of the modified carrying system according to the present invention; indicating a case 10, a flap portion 12 for securing the personal computer, cellular phone, or palm pilot, an added headset case portion 30, and a flap portion 32 for securing the hands-free device.

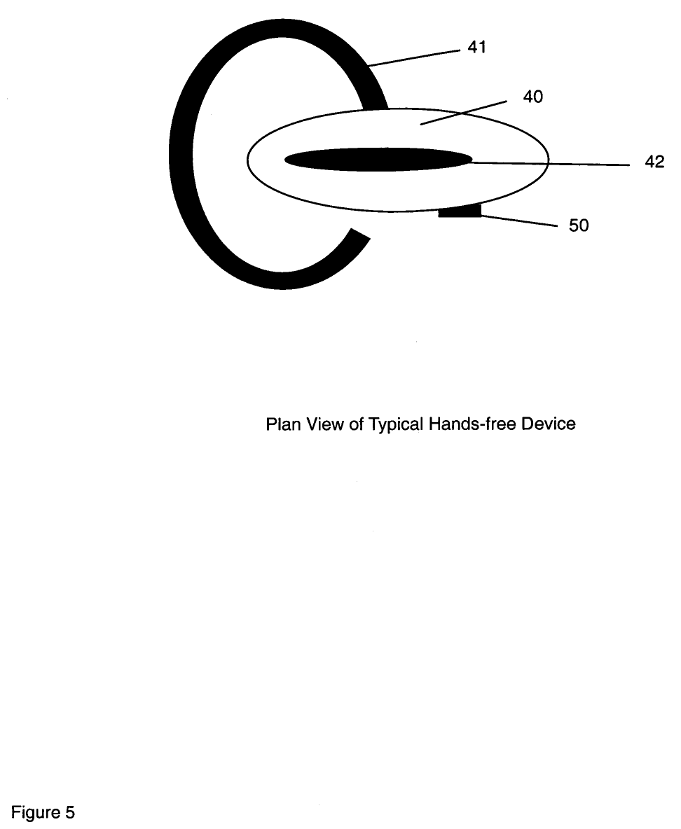

Referring to FIG. 5, a plan view of a typical hands-free headset device indicating a body 40, an ear piece 41, an on/off switch 42, and an added manual sleep switch 50.

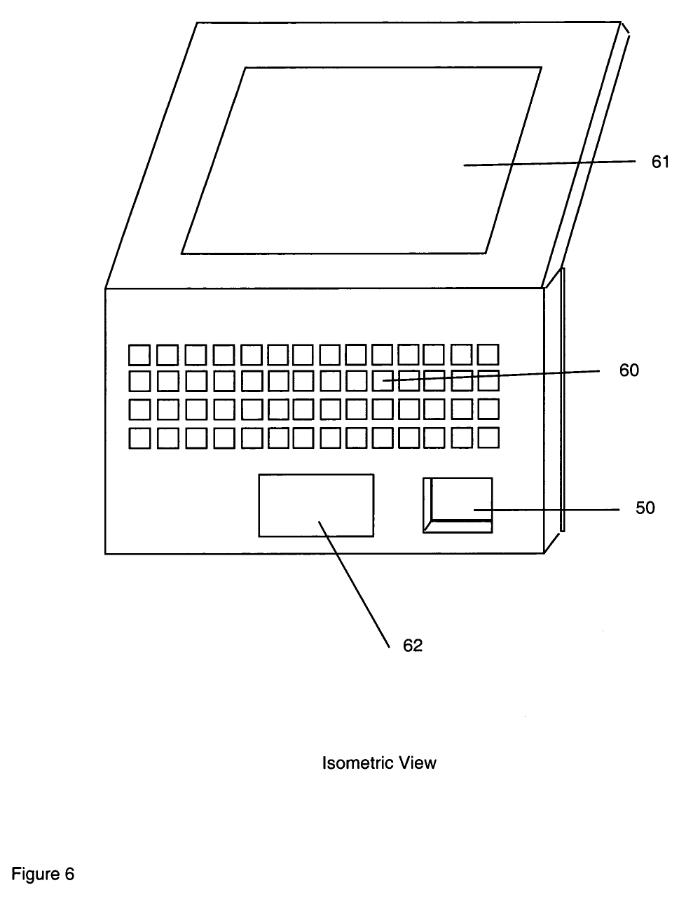

Referring to FIG. 6, an isometric view of the modified personal computer according to the present invention is depicted indicating a typical portable computer with a key board 60, a monitor 61, a mouse pad area 61, and an added clip portion for securing the typical hands-free headset 50 when not in use.

The present invention may be implemented using existing systems with minor modifications according to the teachings of the present specification, as will be apparent to those skilled in the manufacture of personal computers, and cellular phone and palm pilot carry cases. Appropriate hardware can readily be prepared by those skilled in the art based on the teachings of the present disclosure, as will be apparent to those skilled in the manufacturing and assembly arts. The invention may also be implemented by the preparation of application specific integrated manufacturing as will be apparent to those skilled in the art.

Although the preferred embodiment of the present invention is described in terms of utilizing a pocket to hold the hands-free headset portion; the method of attachment could be accomplished by utilizing a clip with specific clearance between the moving parts and/or complimentary offsets between the parts to guard against accidental removal of the hands-free portion as would be apparent to those skilled in the art of mechanical engineering.

Although the preferred embodiment of the present invention is described in terms of a pocket to receive the hands-free headset portion; the pocket could be a preformed extrusion to hold the personal computer, cellular phone, or palm pilot portion and hands-free headset portion as would be apparent to those skilled in the art of mechanical and structural engineering.

Although the preferred embodiment of the present invention is described in terms of a manual switch to place the hands-free headset portion into the sleep mode, the switching of modes could be accomplished by voice commands, as will be apparent to those skilled in the art.

Although the preferred embodiment of the present invention is described in terms of securing the hands-free headset portion compartment within the body of the personal computer, cellular phone, or palm pilot portion; the hands-free headset portion could be mechanically fastened to the existing personal computer, cellular phone, or palm pilot portion pocket by means of a clip as would be apparent to those skilled in the arts.

Although the preferred embodiment of the present invention is described in terms of attaching the hands-free headset portion pocket over the personal computer, cellular phone, or palm pilot portion pocket by means of integral fabrication; the hands-free headset portion pocket could be mechanically fastened to the existing personal computer, cellular phone, or palm pilot portion pocket by means of sewing, welding, riveting, screwing, epoxies, etc. as would be apparent to those skilled in the arts.

The securing method and system of the present invention is functional because it makes readily available for the storage of a hands-free headset portion while not in use, it is reliable because the working parts require very little maintenance beyond what is already necessary in the existing communication system, it is effective because the activation portion of the hands-free headset portion is not readily accessible to accidental activation; therefore reducing the potential of accidentally transmitted data, missed calls, and calls placed by mistake.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A method and system for securing a hands-free headset device for a communication systems that includes a portion for attaching a hands-free headset device, said securing device comprising:
A means for carrying a personal computer, cell phone, or palm pilot;
a means for attaching said carrying device to a belt or shoulder strap;
a means for securing a hands-free headset device.

2. The securing device according to claim 1, wherein the means of securing personal computer, cellular phone, or palm pilot is attached to the means for securing the hands-free constituting an assembly.

3. The securing device according to claim 1, wherein the hands-free headset portion of the securing device could be a clip.

4. The securing device according to claim 1, wherein the hands-free headset portion of the securing device could be a pocket.

5. The securing device according to claim 1, wherein the means of attachment to a belt or strap could be rotatable.

6. A coupling device that includes a first portion of a communication system and a second portion of said communication system, said securing device comprising:
A means for computing/communicating with outside devices;
A means for remote communication with said computing/communicating portion;
A means for coupling said computing/communicating portion and said remote communication portions.

7. The coupling device according to claim 6, wherein the means of coupling the personal computer, cellular phone, or palm pilot to the hands-free headset constitutes an assembly.

8. The coupling device according to claim 6, wherein the means of coupling could be a clip.

9. The coupling device according to claim 6, wherein the means of coupling could be a pocket.

10. The coupling device according to claim 6, wherein the means of coupling could be a integral compartment of said computing/communicating portion.

11. A hands-free headset device portion for said communication system that includes a portion for placing the hands-free headset device portion in a sleep mode for conserving the battery and avoiding erroneously answered and placed calls.

12. The hands-free headset portion according to claim 11, wherein the means to switch the mode is accomplished by means of a manual switch.

13. The hands-free headset portion according to claim 11, wherein the means to switch the mode is accomplished by means of a voice command.
